(19) United States
(12) Patent Application Publication
(10) Pub. No.: US 2014/0010922 A1
(43) Pub. Date: Jan. 9, 2014

(54) Electrostatic Activation of Vaporized Fluids

(71) Applicant: William John Martin, South Pasadena, CA (US)

(72) Inventor: William John Martin, South Pasadena, CA (US)

(21) Appl. No.: 13/544,917

(22) Filed: Jul. 9, 2012

(51) Int. Cl. C12C 12/00; A23L 2/38

(52) U.S. Cl. 426/66; 426/237

(57) ABSTRACT

Methods previously shown to be effective in imparting a prolonged, non-temperature-related, increase in an intrinsic energy of fluids, including water and ethanol, have been applied to heat generated vapors of these fluids, leading to effective activation of the fluids upon their condensation. In a specific embodiment, a Van de Graaf generator was used to apply an electrostatic field to the vapors. The condensed fluids from these electrostatically activated vapors display enhanced internal mobility, more dynamic solubillization patterns using of sprinkled particles of neutral red dye and a progressive, but limited, reduction in measured weight. Fluids condensing from electrostatically-energized vapors can also impart intrinsic energy to other fluids by simple dilution. The described methods are relevant to an understanding of homeopathy.

### CROSS REFERENCE TO RELATED APPLICATIONS

### Co-Pending Patent Applications

Methods for detection of ultraviolet light reactive alternative cellular energy pigments (ACE pigments). William John Martin Submitted Dec. 24, 2007. Publication number 20090163831

Method of assessing and of activating the alternative cellular energy (ACE) pathway in the therapy of diseases. William John Martin Submitted Jan. 16, 2008. Publication number 20090181467

Enerceutical mediated activation of the alternative cellular energy (ACE) pathway in the therapy of diseases. Submitted May 8, 2008. Publication number 20090280193

Regenerative wound healing using copper-silver citrate composition. Submitted Oct. 22, 2008 Publication number: 20100099758.

Enerceutical activation of the alternative cellular energy (ACE) pathway in therapy of diseases. Submitted Feb. 11, 2009. Publication number 20090202442.

Method of using the body's alternative cellular energy pigments (ACE-pigments) in the therapy of diseases Submitted Feb. 20, 2009. Publication number 20100215763

Urine as a source of alternative cellular energy pigments (ACE-pigments) in the assessment and therapy of diseases. Submitted Mar. 5, 2009. Publication number 20100196297

Moringa oil mediated activation of the alternative cellular energy pathway in the therapy of diseases. Submitted Feb. 24, 2010. Publication number 20110208110.

Activation of the alternative cellular energy (ACE) pathway in the therapy of diseases. Submitted Jun. 9, 2010. Publication number 20110306917.

Methods for the detection of alternative cellular energy (ACE) pigments and for monitoring of the ACE pathway in the diagnosis and therapy of diseases. Submitted Jun. 13, 2010. Publication number 20110306077.

Diagnostic value of systemic ACE pathway activation in the detection by fluorescence of localized pathological lesions. Submitted Jul. 26, 2010. Publication number 20100291000 Enerceutical mediated activation of the alternative cellular energy (ACE) pathway in the therapy of diseases. Submitted July 2010.

Energy Charged Liquids to Enhance Enerceutical Activation of the Alternative Cellular Energy (ACE) Pathway in the Therapy of Diseases. Submitted Dec. 17, 2010. Publication number 20120152755

Energy Charged Alcoholic Beverages for Enhancing the Alternative Cellular Energy Pathway in the Prevention and Therapy of Diseases. Submitted January 2011, Publication number 20120171340.

Methods for Detecting and Monitoring the Activity of Energized Water and Other Liquids Useful for Enhancing the Alternative Cellular Energy Pathway in the Prevention and Therapy of Diseases. Submitted February 2011

Methods for Increasing the Kinetic Activity of Alcohol, Water and Other Liquids, so as to Render the Liquids More Useful in Enhancing the Alternative Cellular Energy Pathway in the Prevention and Therapy of Diseases. Submitted February 2011

Methods for Increasing the Kinetic Activity of Water and Other Liquids, so as to Render the Liquids More Useful in Enhancing the Alternative Cellular Energy Pathway and in Various Other Agricultural and Industrial Applications. Submitted June 2011.

Methods for Increasing the Kinetic Activity of Water and Other Liquids, so as to Render the Liquids More Useful in Enhancing the Alternative Cellular Energy Pathway and in Various Other Agricultural and Industrial Applications. Submitted October 2011.

Use of Plants Extracts to Activate Water, Alcohol and Other Liquids. Submitted Oct. 27, 2011. Application Ser. No. 13/272,215.

Methods of Transferring Energies to Water, Alcohols and Minerals. Submitted Nov. 25, 2011. Application Ser. No. 13/304,558.

Weight Change as a Measurement of an Intrinsic Energy Property of Matter. Submitted Dec. 27, 2011. Application Ser. No. 13/340,669

Weight Change as a Measurement of an Intrinsic Energy Property of Foods and Other Materials, Submitted Jan. 5, 2012.

### OTHER RELATED OR REFERENCED PATENTS AND PATENT APPLICATIONS

Brown, Yull. Welding. U.S. Pat. No. 4,014,777 Issued Mar. 29, 1977.

Kang, Song Doug. Method of treating or alleviating the symptoms of a lesion in mammal. Patent application number 20100173008 Published Jul. 8, 2010

Chen, Ho-Hsien, Huang, Tzou-Chi, Huang, Hao-Hsun, Tung, Jung-Chang. Method for generating high concentration chlorine dioxide by means of electrolysis. Patent application number 20080308428. Published Dec. 18, 2008.

### STATEMENT REGARDING FEDERALLY SPONSORED RESEARCH OR DEVELOPMENT

Not applicable: No Federal funding was received in support of this patent application.

### REFERENCE TO SEQUENCE LISTING, A TABLE OR A COMPUTER PROGRAM LISTING COMPACT DISK APPENDIX

Not applicable.

### BACKGROUND OF THE INVENTION

In the co-pending and abandoned patent applications, incorporated herein by reference, methods have been described for increasing an intrinsic energy quality of materials. A major focus has been on water, ethanol, alcoholic beverages, foods and living organisms. Humans and animals synthesize compounds that provide cellular energy via a mechanism distinct from food catabolism. This non-mitochondria/non-food metabolic process is termed the alternative cellular energy (ACE) pathway and the energy synthesized transducing materials are termed ACE pigments. The ACE pathway was initially identified as enabling tissue culture cells to recover from the damaging effects caused by stealth adapted viruses, which are not effectively recognized by the cellular immune system. Certain chemical compounds, including neutral red dye, have some similarities with ACE pigment and have been used in the therapy of stealth adapted and other virus infected individuals. The clinical methods being developed have additional widespread potential applications in would healing, regenerative medicine and in the therapy of illnesses with impairments in oxygen and/or blood supply, such as emphysema and stroke.

Additional research can be summarized as follows: ACE pigments collected from stealth adapted virus cultures comprise a range of aromatic and aliphatic chemicals in association with a variety of minerals. The materials can self-assemble into discrete particles, which display a variable range of energy transducing properties. These include fluorescence when illuminated with ultraviolet (UV) light with enhancement of the fluorescence occurring when the particles are mixed with certain dyes, including neutral red and acridine orange; non-Brownian movements within fluids with intermittent inter-particle attraction and repulsion, leading to variable sized, dynamic aggregates; self assembly into larger particles, threads and ribbons; ferromagnetism; electrolysis (production of gas bubbles in water); and both electron donating (reducing) and electron accepting (oxidizing) activities. Long fibers, threads and pyramid-shaped structures can also form within virus cultures. Comparable ACE pigments can also be derived from the skin, hair and bodily fluids (urine and saliva) of patients infected with stealth adapted viruses. While they may be directly fluorescent under UV illumination, their identification is enhanced using neutral red and acridine orange dyes. The fluorescence fades upon prolonged UV exposure suggesting they are becoming more fully charged by the UV light and beyond the level of absorbing further energy. ACE pigments on the skin can be irritating and their electrostatic movements can lead to their being mistaken for parasites. Indeed, the excessive production of ACE pigments can result in a diagnosis of delusional parasitosis or Morgellon's disease.

Neutral red dye stained HSV and HPV skin lesions also brightly fluoresce when illuminated with UV light, due to the local formation of ACE pigments. Interestingly, the evoked fluorescence involves both the applied neutral red dye and adjoining areas of the stained lesions, or, if present, more distant non-stained virus lesions. UV light exposure of neutral red stained HSV skin lesions expedites healing of the localized skin lesions, as well as distant unstained non-illuminated skin lesions. These observations are consistent with there being a reciprocal relationship between neutral red dye and the body's ACE pigments, such that if either is activated, it can lead to activation of the other, even without direct physical contact.

Systemic activation of the ACE pathway can also be achieved using activated neutral red dye in patients without a localized HSV or HPV skin lesions. Lidocaine (xylocaine) was dissolved in ethanol and mixed with minute quantities of various herbal tinctures and diluted as a homeopathic formulation. The solution had a remaining 10% ethanol concentration and yielded bright fluorescence with the addition of neutral red dye. Paper towels containing the solution and freshly prepared neutral red dye were laid onto skin areas in which there had been prior outbreaks of HSV. Even without any direct contact between the dye solution and the skin, after several minutes, the underlying skin area would begin to show fluorescence when it was directly illuminated with UV light. Such treated patients had a markedly reduced rate of recurrence of HSV skin lesions.

The next series of studies involved patients with stealth adapted virus-related illnesses, including the chronic fatigue syndrome, Morgellon's disease, mental illnesses and, in particular, children with autism. Paper towels with the solution plus dye were placed onto different skin areas of the patients and direct contact of the solution with the skin prevented by using Sarin wrap. Systemic activation of the ACE pathway was clearly being achieved by the appearance of UV fluorescence in other skin locations and within the oral cavity. More impressively, were the consistent improvements in many symptoms, including mental clarity. Several autistic children underwent repeated treatments with only partial reversion towards the pre-therapy level of clinical impairments. Black plastic covering could be used instead of Sarin wrap indicating that the energy transfer from the UV illuminated solution to the body's ACE pathway was not simply mediated by visible fluorescence.

For reasons, which I could not explain at the time, the solution lost its prior effectiveness and there was mounting disappointment among some of the new parents participating in the clinical trial. Previously noted dynamic movements of neutral red particles sprinkled onto the solution were much less noticeable, as was the brightness of the yellowish fluorescence when the neutral red containing solution was illuminated using a UV light. I had previously noted that neutral red would variously fluoresce even when dissolved in high concentrations of ethanol and I subsequently read a much earlier published report confirming this observation. It occurred to me that the loss of activity of the solution might have occurred because of selective evaporation of ethanol. In reformulating the product, I sensed that the Lidocaine and herbal tinctures were helping to retain the kinetic activity shown by higher concentrations of ethanol. These additives, therefore, appeared to be energizing the ethanol.

Various methods have been suggested for energizing water with claims that consumption of the water can provide benefits beyond those achieved from consuming regular water. The data supporting the clinical claims are not entirely convincing because the benefits of simply increasing the intake of water or resulting from optimism and wish fulfillment and not typically addressed.

I, therefore, undertook studies on various proposed methods for activating water. These methods include the use of ceramic materials, including magnesium oxide pellets (referred to as prills) and naturally occurring zeolites, humic and fulvic acids, mica, tourmaline, various crystals and clays. Basically all of these compounds are electrostatically-bonded but non-conductive molecular complexes, which typically form into colloids when dispensed into water. While they are regarded as a potential source of minerals, they also appear to work even if enclosed into a separate container, for example as a “Stir-Wand.” Solid balls made from ceramic materials are also commonly used with unconfirmed suggestions that they may emit vibrational energies and/or far infrared radiation. Similarly, certain of the crystals used for modifying water, for example ANCHI (ancient Chi) crystals, are thought to radiate a vibrational energy, which can be absorbed by and modify the activity and possibly the structure of water.

Electrolysis is another popular approach at energizing water. It is achieved by using electrically charged anode (+) and cathode (−) electrodes placed into electrolyte-containing and, therefore, electrically conductive water. The water forming near the cathode becomes more alkaline with a higher hydrogen concentration than untreated water and is said to have health benefits. The efficiency of electrolysis can be enhanced by providing additional energy sources to the water, such as magnetism, infrared radiation and sound (Lockhart; Michael D. Methods for enhancing electrolysis. Patent application number Published Apr. 26, 2012). Minerals such as silver particles can also enter into the electrolyzed water from the electrodes. The salts used as the electrolytes can also become modified by the electrical charging process. For example, the chloride ion of sodium chloride can be converted to chlorine dioxide, which is stated to have healing properties (Chen, Ho-Hsien, Huang, Tzou-Chi, Huang, Hao-Hsun, Tung, Jung-Chang. Method for generating high concentration chlorine dioxide by means of electrolysis. Patent application number 20080308428. Published Dec. 18, 2008.)

Electrolysis of water can also generate an ignitable form of water vapor, regarded by some investigators as being distinctly different from hydrogen gas (emitted from the cathode) and from oxygen gas (emitted from the anode). The mixture of all three gases is referred to as Brown's gas and was initially used for welding (Brown, Yull. Welding. U.S. Pat. No. 4,014,777 Issued Mar. 29, 1977). The consumption of water through which Brown's gas has been bubbled is reported on several internet sites as being able to improve a person's overall health. Indeed, a pending patent application states that even blowing Brown's gas onto a site of symptomatic tissue damage can alleviate the symptoms (Kang, Song Doug. Method of treating or alleviating the symptoms of a lesion in mammal. Patent application number 20100173008 Published Jul. 8, 2010.) Rather than relying on electrolysis, a strong magnetic field also appears capable of generating ignitable water vapor Klein, Dennis J Apparatus and method for the conversion of water into a clean burning combustible gas for use as an additive with other forms of fuels. Patent application number 20070151846. Published Jul. 5, 2007.) Magnets as well as other stirring devices have also been used to vortex water with claims of adding to the water's health benefits. The earth itself provides a magnetic field, which can interact with the electrostatic properties of water and of it's various naturally occurring mineral and other constituents.

I undertook a series of studies to test these and other suggested methods for energizing water. I used both regular tap and store purchased bottle water as controls and also used some water obtained from an aquifer, reported as having health promoting benefits. These studies led to the development of a neutral red kinetic assay as a means of assessing the intrinsic activity of the treated water, compared to the same water prior to its being treated. In the neutral red kinetic assay (NR-kinetic assay) the dye is sparsely sprinkled onto a small, open dish of the water and the dissolving pattern of the dye are examined using an inverted microscope. In highly energized water, the added neutral red dye will display rapidly forming linear streaks, followed by to-and-fro movements of remaining non-dissolved fine particles. Many of the non-dissolved particles form into one or a few loose aggregates from which individual particles are periodically repulsed, only to slowly return back towards the aggregate(s), before being again repulsed. This pattern is strikingly different from the static, slow concentric dissolving patterns seen when neutral red dye is sprinkled onto non-energized, pretreated water samples. Moreover, the aggregation and repulsion pattern being observed was very similar to the microscopic movements, which I had previously seen when examining ACE pigments in cultures of stealth adapted viruses. Quantifying the kinetic activity of sprinkled neutral red dye provided a useful semi-quantitative assay to evaluate the level of activation of water and to confirm at least low-level activation using ceramics, electrolysis and other previously recommended procedures. The experiments also indicated a correlation between the NR-kinetic assay and the various common attributes of ceramics, magnetic and electrolysis activated water.

I also used the NR-kinetic assay to examine ethanol and alcoholic beverages. Considerably higher baseline dynamic NR-kinetic activity occurs when neutral red dye is sprinkled onto 100% ethanol and high (40%) ethanol content alcoholic beverages, compared to that seen with water. The kinetic activity of ethanol and alcoholic beverages can, nevertheless, be markedly further enhanced beyond the background and far in excess of that seen with the energized water.

Highly energized water will fluorescence under UV illumination and the background fluorescence seen with regular ethanol can be markedly increased following its activation. Threads of neutral red dye form in energized fluids and complex patterns of dried dye are seen if the energized fluids are allowed to dry.

Each of several previously recommended procedures for energizing water was found to be much more effective in energizing ethanol and alcoholic beverages. Among additional new methods evaluated, considerable success was achieved with electrostatic stimulation of a Van de Graaf generator or provided by either one or both of the leads from a car battery charger inserted directly into the fluids. Further activation of various fluids was achieved by taking a somewhat energized ethanol, adding approximately 0.1 mg/ml neutral red dye, sealing the mixture into a Ziploc bag, placing the bag onto other partially energized or even non-energized fluids and illuminating with UV light for several hours. In essence, I could apply the same procedure used to activate the ACE pathway in patients to the direct and/or further activation of many fluids, including alcoholic and non-alcoholic beverages. Unprocessed ethanol with neutral red dye was far less effective than using the more activated solutions. The effectiveness of the energized ethanol and beverages in systemically activating the ACE pathway was confirmed with the assistance of the parent of an autistic teenage girl and in other clinical studies.

I next observed that the measured weight of energized solutions would progressively become reduced following the activation procedures. Using a balance sensitive to 0.1 mg, reductions of 0.2 to >2 mg/ml of solutions were consistently observed with energized fluids. Moreover, adding previously energized fluid to regular fluid, e.g. as a 1:10 dilution, would initiate a process leading to the reduction in overall weigh with evidence for spreading of the activation throughout the fluid. The sequential reduction in weight of added regular water could be sequentially repeated upon further daily 1:10 dilutions of the activated fluid.

Along with the NR-kinetic assay, the progressive reduction in measured weight of sequentially diluted energized solutions in caped containers has led to the following hypothesis: Gravity-related energy, as well as other energies, are involved in the progressive loosening of inter-molecular ionic bonding, including hydrogen bonds. The absorbed energies seemingly act via a repulsive force on the normally attracting, opposing electrical charges. The breaking of ionic bonds leads to increased internal mobility within the energized material and the diversion of the force of gravity leads to a reduction in the measured weight of the energized materials. The process is progressive and is seemingly accompanied by the emission of a force capable of similarly loosening the ionic bonding within other materials, even without direct contact. Pyramid-shaped structures and alternating layers of conductive and non-conductive materials can enhance the transmission of the emitted energies. From a medical perspective, the emitted energy is extremely important because it can activate the body's ACE pathway and can, thereby, facilitate cellular survival, cellular repair and the body's anti-infection defense mechanisms. Additional data support the tentative hypothesis including the finding that energized water can fluorescence under UV illumination and the background fluorescence seen with regular ethanol is markedly increased following activation. Moreover, threads of neutral red dye can be formed via a reversible electrostatic bonding process, as can long fine needles of added xylocaine, under the influence of the electrostatic force modifying energies.

The purpose of the present patent application is to report on the usefulness of extending the actual methods of energizing water and ethanol to the energizing of vapors. The vapors, as well as the condensed fluids from the activated vapors, have been useful in the activation of additional fluids. An illustrative method uses the electrostatic energy provided by a Van de Graaf generator to activate vapors from boiled water and boiled alcohol.

### BRIEF SUMMARY OF THE INVENTION

Water and ethanol vapors condensing within a plastic bag in which an electrostatically charged dome of a Van de Graff generator is enclosed, gains greater intrinsic energy, compared to vapors condensing in a plastic bag in which the dome of a van de Graaf generator is not electrostatically active. The intrinsic energy of the fluid condensing from the treated vapors is assessed by the neutral red kinetic assay. It is also confirmed by measuring the progressive reduction in weight of an aliquot of fluid obtained shortly after it condenses, or of regular fluids to which some of the energized fluid is freshly added. The observations extend to vapors what had been previously noted in energizing liquids.

### BRIEF DESCRIPTION OF THE DRAWINGS

Not Applicable and none included

### DETAILED DESCRIPTION OF THE INVENTION

The Van de Graaf generator used in most of the experiment was purchased from Chaney Electronics (Scottsdale AZ, Item Number C6917). It is typical of many small Van de Graff generators available on the internet or constructed from individually purchased components. It comprises a small rotary motor powered by four 1.5 volt Type C batteries. The motor is connected to a 1″ diameter lower rotor composed of silicone rubber. This rotor is able to drive a slightly stretched, thin, 7/8″ wide rubber band in a narrow elliptical motion around an upper ¾″ wide nylon roller, with spacing of 10.5″ between the axel of the silicone rubber rotor and that of the nylon roller. The motor and the lower rotor are mounded onto a metal bracket attached to a plastic base plate of the apparatus. A small strip of copper with fine, comb-like projections extends from the metal bracket to just beneath the rubber band on the lower rotor. The upper rotor is held in place by attachment to near the top of a 3/4″ square plastic column, which extends from the base plate of the apparatus. A strip of copper with fine, comb-like small extensions is screwed onto the top of the plastic column and positioned to be just slightly above the rubber band on the upper roller. The screw at the top of the column also holds a metal bracket with a 1″×1.5″ platform onto which a 5″ wide, 2.5″ high semicircular aluminum dome can be placed. The dome has a small magnet welded onto the inside of a flattened area at the top of the dome, to help stabilize the dome onto the upper metal bracket. A flip switch controls the current from the battery to the motor. When the motor is running, charges from the silicon rubber are transferred to the rubber band and are in turn transferred to the outer surface of the dome.

The Van de Graaf generator has been previously used to directly activate fluids by placing a tightly capped plastic or glass container of the fluids onto the dome and fixing the container in place, if necessary. From 10-30 minutes of charging would typically be employed and the container weigh before and after electrostatic charging. A progressive reduction in weight of the fluid and container was consistently noted after the charging had occurred. The reduction in weight could not be attributed to any temperature change or leakage of actual fluid from the container. It was initially quite rapid but persisted, even over several days. Moreover, an 1:10 aliquot of the treated fluid was effective in reducing the measured weight of a sample of regular fluid, when mixed into another container and tightly capped. The directly and indirectly charged fluids also displayed increased dynamic activity using the NR-kinetic assay.

The new procedure involved the electrostatic activation of the vapor phase of fluids, rather than fluids within a closed container. In this procedure, approximately 500 ml of distilled water were added to a kettle, which was placed onto a temperature-calibrated electric plate. One end of a 2-foot long, 1″ diameter, copper tubing was tightly inserted into the spout of the kettle and fixed into place using aluminum tape. The copper tubing was positioned with a stand so that its other end would be approximately 2″ above the dome of the Van de Graaf generator, when it was put in place. Before doing so, the hot plate was turned on and the fluid in the kettle heated to just above 100° C. This resulted in a steady stream of water vapor flowing out from the top of the copper tubing, which became quite hot. At this time, the dome of the Van de Graaf generator was placed into the bottom corner of a heat resistant nylon resin bag (Reynolds Oven Bag, Richmond Va.). The bags used measured either 16×17.5 or 19×23.5 inches. A small magnet is used to help invert the bag into the inner part of the dome with a small opening made to ensure metal-to-metal contact with the upper metal bracket of the Van de Graaf generator. The Van de Graaf generator was then positioned beneath the top end of the copper tubing and switched on. The open end of the nylon resin bag is loosely wrapped around the copper tubing, to allow the release of excess vapor, while the other lower end of the nylon resin bag is positioned below the dome, so as to collect the condensing fluid. A similar setup is used in control studies, except that the Van de Graaf generator is not turned on during the condensation process.

The condensed water samples were assessed for activity using the NR-kinetic assay, neutral red fluorescence assay and weight reduction measurements. The weight reduction testing was done with samples of the freshly formed water condensate after it had cooled to room temperature. In each of several experiments, running of the Van de Graaf generator during the fluid condensation and collection process, resulted in considerably more dynamic activity using the NR-kinetic assay, enhanced fluorescence and most noticeably, much more rapid measurable reduction in weight, typically exceeding 0.5 mg/ml within an hour period and being more than 5 times that of any observable weight reduction in the control fluid collected without a running Van de Graaf generator. A subjective impression was also obtained that inhaling some of the released water vapor in experiments using the generator evoked a somewhat different and more pleasurable experience than inhaling water vapor formed when the generator was not running

The next series of experiments used 200 proof ethanol purchased from Sigma-Aldrich and Ever Clear alcoholic beverage (155 proof) purchased from a local liquor store. In these experiments, a small plastic tube was added to the top end of copper tubing for insertion into the nylon resin bag as a precaution against possible sparking from the dome of the Van de Graaf generator to the copper tubing. Again, electrostatic charging of the vaporized ethanol enhanced its reactivity using the NR-kinetic assay, intensity of fluorescence and, especially reduction in measured weight (Sometimes exceeding 2 mg/ml within an hour measurement time and 10 times greater than any observed changes seen with control ethanol).

The foregoing studies are significant because they extend prior observations on fluids to the vapor phase of the fluids. This approach has proven to be quite effective and to be well worth the additional effort required to generate the vapor. Ongoing studies are confirming that other modes of activation of fluids, for example, using electrodes from a car battery charger, an electrolysis apparatus designed for use with water, various ceramics including those listed in this patent application, minerals, etc, can be effectively adapted for use on the vapors derived from various fluids. Nor are the fluids being vaporized restricted to water and ethanol containing liquids, but can include other volatile fluids, such as other alcohols, acetone, essential oils, etc. Indeed, materials normally present as gasses, can be used, e.g. ozone, oxygen and nitrogen can conceivably be similarly activated. The activated vapors and gases can also be directly bubbled into other fluids. Activated fluids have many potential uses beyond enhancing the ACE pathway in humans, animals and plants. Activated water can be used in numerous industrial applications, including anti-fouling of water-cooling tower, more easily dispersed cement, etc. Also of basic scientific interest is the possible electrostatic activation of the atmosphere as an explanation of the cause of the powerful updrafts seen in electrical storms and in tornados, and for the manipulations of such events.

Another important development from the studies has been confirmation that the condensed, Van de Graaf generator energized, water and ethanol vapors, are quite capable of directly energizing other fluids. This was achieved by diluting the condensed, electrostatically-energized fluids into regular fluids, including water and ethanol containing beverages, typically at a 1 in 10 dilution. Proof of cross activation was obtained using the NR-kinetic assay and by observing a progressive reduction in weigh following the mixing of the solutions in another container, which was then tightly capped before being weigh. The electrostatically activated water and ethanol fluids have remained active beyond a month. The assays are also helpful in confirming ways of further enhancing the intrinsic energy activity of different fluids, including the addition of components, such as xylocaine and minerals.

The secondarily diluted solutions could be further used to energize additional fluids, which could then be subsequently used to energize yet more additional fluids. Measurable, secondary activation was achievable even with a 1:50 dilution of an energized fluid added to regular fluid, although not as effectively as a 1:10 or even more concentrated dilution, e.g. 1:2. A day or more spacing between successive dilutions was typically provided to allow for more complete secondary and further activations. The container of the energized fluid being used to make the dilution was also jolted 20-30 times prior to transferring the fluid to another fluid. This approach was based on the practice of succussion being used prior to making homeopathic dilutions. Indeed, the science and practice of homeopathy may be little more than that of adding to the intrinsic energy of a fluid suitable for injection and could be easily achieved using the approach described in the present patent application.

The capacity to achieve secondary activation of other fluids has been adapted to methods of assessing the intrinsic activity of other fluids. For example, once water is fully energized there is no further reduction in its weight upon the 1 in 10 fold addition of a previously energized fluid. With partially energized fluids, a lower level of weight reduction will be seen when compared to the same type of test fluid, which is non-energized. This type of assay can be applied to drinking water, water for irrigation, water treated by other devices and even to bodily fluids, e.g. urine. A corollary of this approach is to dilute a test fluid, including for example homeopathic formulations, essential oils, etc., into a non-energized water or other fluid and to assess the rate and achieved level of weight reduction over an ensuring time period, e.g. 1 or 2 hours.

On a practical note, maximally energized solutions are being obtained by further activating the electrostatically activated condensed ethanol by using overnight UV illumination of a portion of the fluid mixed with a small quantity (−0.1 mg/ml) of freshly added neutral red dye, in a sealed Ziploc bag floated onto the surface of the remaining fluid. The highly activated fluids are being used to generate consumable water for used inn clinical trials and to also help to better understand the form of energy emanating from the fluid, which is effective in activating the body's ACE pathway. Minor additional uses include using small amounts to enhance the taste of other fluids, such as wine; applying to superficial skin wounds to promote healing; use as a face and body wash to help improve complexion; soaking of vegetables; watering plants; adding energized ethanol to gasoline to potentially improve combustion and gas mileage; and many other uses. As noted previously, highly energized fluids can activate other fluids by simply being placed in close proximity to another fluid.

While this invention has been disclosed with reference to specific embodiments, it is apparent that others skilled in the art may devise other embodiments and variations of this invention without departing from the basic spirit and scope of the invention. Numerous variations and modifications may be effected in the energizing of materials in their gaseous phase without departing from the spirit and scope of the invention. Many other approaches are available for providing electrostatic-related energies, including electrical discharge from capacitors. Energies can also be emitted from ceramics, including tourmaline and from physical shapes, including pyramids with certain defined dimensions. It is to be understood that no limitation with respect to the specific inventions disclosed herein is intended or should be inferred from the scope of the claims. The scope of the claims is restricted to avoid having to make a subsequent election of only some of the claims. Many other claims can and will be subsequently made on the information disclosed in this application.

1. A method for increasing the intrinsic energy of a fluid, comprising exposing to an electrostatic field, vapor generated by boiling of the fluid and subsequently collecting a condensate of the electrostatic field exposed vapor; such that a sample of the energized condensate will show enhanced linear and to-and-fro movements of particles of neutral red dye sprinkled onto the fluid, when compared to the movements of particles of neutral red dye sprinkled onto comparable fluid obtained from vapor, which had not been deliberately exposed to an electrostatic field and also that the energized condensate will show a progressive, but limited, reduction in its specific gravity when compared to a condensate of the vapor of the same type of fluid, but which had not been deliberately exposed to the electrostatic field.

2. A method for imparting intrinsic energy to a regular fluid by adding a portion of the fluid energized as described in claim 1 to the fluid in an amount ranging from 1:2 to 1:50 dilution by volume, such that a sample of the diluted fluid will show enhanced linear and to-and-fro movements of particles of neutral red dye sprinkled onto the fluid, when compared to the movements of particles of neutral red dye sprinkled onto the undiluted, regular fluid also that the diluted fluid will show a progressive, but limited, reduction in its specific gravity when compared to the regular fluid.

3. A method for determining the relative intrinsic energy level of a given fluid with regards to that of a reference fluid, by comparing the ability of fluid derived using the method of claim 1, to impart intrinsic energy to the given fluid when compared to the level of intrinsic energy that is imparted to the reference fluid; and also by comparing the ability of a dilution of the given fluid with that of a similar dilution of fluid derived using the method of claim 1, to impart intrinsic energy to samples of regular fluid.

4. The method of claim 1 in which the electrostatic field is generated by a Van de Graaf generator.

5. The method of claim 1 in which water is the fluid from which the generated vapor is exposed to an electrostatic field.

6. The method of claim 1 in which ethanol is the fluid from which the generated vapor is exposed to an electrostatic field

7. The method of claim 1 in which an alcoholic beverage is the fluid from which the generated vapor is exposed to an electrostatic field.

8. The method of claim 2 in which water is the fluid to which intrinsic energy is imparted

9. The method of claim 2 in which ethanol is the fluid to which intrinsic energy is imparted

10. The method of claim 2 in which an alcoholic beverage is the fluid to which intrinsic energy is imparted
